(19) United States
(12) Patent Application Publication
(10) Pub. No.: US 2026/0180380 A1
(43) Pub. Date: Jun. 25, 2026

(54) STATOR OF A ROTARY ELECTRIC MACHINE, COMPRISING FOLDABLE CONSTRICTIONS

(71) Applicant: MOTEURS LEROY-SOMER, Angouleme (FR)

(72) Inventor: Patrick VOHLGEMUTH, Anais (FR)

(73) Assignee: MOTEURS LEROY-SOMER, Angouleme (FR)

(21) Appl. No.: 19/129,396

(22) PCT Filed: Nov. 10, 2023
(86) PCT No.: PCT/EP2023/081442

§ 371 Date: May 13, 2025

(30) Foreign Application Priority Data
Nov. 15, 2022 (FR) 2211860

(51) Int. Cl. H02K 1/16; H02K 15/026; H02K 15/065

(52) U.S. Cl. CPC H02K 1/165; H02K 15/026; H02K 15/065

(57) ABSTRACT

A stator of a rotary electrical machine, includes a stator mass having a plurality of slots and a winding in the slots, the winding including bundles of round wires, at least one slot or each of the slots including a plurality of round wires which follow one another circumferentially, and at least one slot or each of the slots being open towards an air gap in the machine and including two foldable constrictions that partially close the corresponding slot.

### TECHNICAL FIELD

The present invention relates to rotary electric machines and more particularly to the stators of such machines.

### PRIOR ART

In known stators, the yoke of the stator forms slots that are completely open or semi-open toward the air gap, such that it is possible to install windings. Generally speaking, the semi-open slots receive electrical conductors which have a circular cross section and are disposed loosely, while the completely open slots accommodate electrical conductors which have a rectangular cross section and are disposed in orderly fashion.

The completely open slots are characterized by the fact that they emerge into the bore of the stator over their entire width, whereas the semi-open slots, which also emerge into the bore, only do so through a significantly narrower opening. This restriction corresponds to a local widening of the teeth located on either side of the slot; these portions are commonly referred to as slot isthmuses.

To retain the conductors in the slot, use can be made of either a rigid wedge, of rectangular profile, which slides in the grooves specially formed for this purpose in the teeth, or a flexible wedge, of the “paper insulation” type with a curved profile, which is inserted between the conductors and the isthmuses.

Stators in which the slots can be closed by non-magnetic wedges are known. However, such wedges run the risk of becoming detached and interfering with the operation of the machine.

Patent application EP 1 283 583 relates to a stator comprising wires which have a width substantially equal to the width of the slot. This stator is intended for a low-voltage, such as 12 V or 24 V alternator.

There is a need to benefit from a stator of a rotary electric machine which is easy to assemble and allows the slots to be efficiently filled, while still providing satisfactory electromagnetic performance. There is also a need to further improve the stators of electric machines and notably reduce the torque ripples.

### SUMMARY OF THE INVENTION

The invention aims to meet this need and does so, according to one of its aspects, by means of a stator of a rotary electric machine, comprising a stator mass having a plurality of slots and a winding disposed in the slots, the winding comprising bundles of round wires, at least one slot, or even each of the slots, comprising multiple round wires which follow one another circumferentially, and at least one slot, or even each of the slots, being open toward an air gap of the machine and comprising two foldable isthmuses that partially close the corresponding slot.

The stator comprises a stator mass which can be produced by stacking magnetic laminations, the slots being made by being cut out of the laminations. The slots are closed at the air gap by foldable isthmuses which may be integral with the rest of the laminations forming the stator mass.

In a variant, the stator mass can be at least partially made by an additive manufacturing technique, notably by powder sintering and machining. The stator may comprise a plurality of stacked slices each made by additive manufacturing.

It is possible for the stator according to the invention to not have fitted magnetic wedges. This eliminates the risk of detachment of the slot closing wedges.

The presence of slots semi-closed by the foldable isthmuses makes it possible to mechanically reinforce the stator and reduce vibrations. This minimizes the cogging torque. This stator makes it possible to greatly reduce the electromagnetic interference linked to the presence of the slot openings opening onto the air gap in the prior art.

In addition, because the slots are semi-closed by the foldable isthmuses, the risk of impregnating varnish leaking toward the air gap is reduced. This reduces the quantity of varnish or resin that is lost and the necessary cleaning operations.

The stator mass may comprise teeth formed between the slots. Thus, each slot is semi-closed at the air gap by two foldable isthmuses connected to two consecutive teeth of the stator mass.

A “foldable isthmus” is understood to mean that an isthmus has a bridge of material that connects it to the tooth and is deformable, so as to allow a change in the orientation of the isthmus in relation to the corresponding tooth. The foldable isthmus may be movable between a first position in which it extends into the bore of the stator and a second position in which it partially closes the opening of the slot, and extends in the continuation of an edge of the tooth defining the bore of the stator.

The foldable isthmuses are disposed at the foot of the corresponding tooth. The foldable isthmuses are integral with the adjacent teeth. Each tooth may have at least one foldable isthmus, notably two foldable isthmuses.

Two consecutive teeth are connected on the opposite side by a yoke. The yoke is integral with the teeth. The stator thus does not have a yoke attached to a toothed ring.

At least one slot, or even each of the slots, may be open toward the bore of the stator. At least one slot, or even each of the slots, may comprise multiple round wires which radially follow one another.

The winding has round wires. A diameter of the round wires may range between 0.8 and 2 mm. The diameter of the wires is small compared to the size of a slot. A ratio of the wire diameter to a slot width may be less than 0.5, better less than 0.6, better still less than 0.7, if not less than 0.8, or even less than 0.9.

The round wires may be arranged substantially in staggered fashion in the corresponding notch.

The slots of the stator may receive a superposition of corresponding bundles of different phases; the bundles of different phases may be isolated by thin insulation, from one another and from the stator mass. The bundles may consist of a variable number of turns; the turns may have a variable quantity of parallel wires, and these parallel wires may have a mixture of different diameters.

### SUMMARY OF THE INVENTION

At least one foldable isthmus, better all the foldable isthmuses, may have a length greater than 2 mm, better greater than 2.5 mm, or even greater than 3 mm. At least one foldable isthmus, better all the foldable isthmuses, may have a length less than 10 mm, better less than 9 mm, or even less than 8 mm. At least one foldable isthmus, better all the foldable isthmuses, may have a length corresponding to 20% to 45% of the width of the slot. The foldable isthmuses may be quite long, since in their folded-down position, the foldable isthmuses almost completely close the slots.

At least one foldable isthmus, better all the foldable isthmuses, may be connected to the corresponding tooth by a bridge of material delimited by a cutout formed at the slot. The presence of the cutout makes it possible to encourage the folding-down of the corresponding foldable isthmus for partially closing the slot.

When the foldable isthmus is folded down, it extends in the continuation of the edge of the corresponding tooth defining the bore of the stator.

The cutout may have a triangular overall cross section, notably when the isthmus is folded open. The cutout forms a notch at the base of the foldable isthmus, which makes it possible to encourage the folding-down thereof after the wires are inserted. It may be triangular or any other shape.

The two foldable isthmuses that partially close a slot can form a slot opening between them. A width of the slot opening formed between the two foldable isthmuses of the slot may, when the isthmuses are folded down, be less than 40% of the width of the slot, better less than 30%, being for example around 20% of the width of the slot. This narrowing of the opening is particularly advantageous because it contributes to improving the waveforms at the outlet of the stator.

For example, an opening having a width slightly greater than the air gap is a good compromise. The width of the slot opening may, when the isthmuses are folded down, be greater than the width of the air gap. In this configuration, the quality of the signal may be improved, without thereby needlessly short-circuiting a portion of the magnetic flux in the stator.

The two foldable isthmuses that partially close a slot can form a slot opening between them. A width of the slot opening formed between the two foldable isthmuses of the slot may, when the isthmuses are folded open, be greater than 60% of the width of the slot, better greater than 70%, being for example around 80% of the width of the slot. For a known semi-closed slot, the ratio may be around 50%.

At least one slot, better all the slots, may have a flat end wall. The edge of the slot defining the end wall of the slot may be at least partially rectilinear.

At least one slot, better all the slots, may have two mutually parallel radial edges. The slots may be substantially rectangular.

At least one tooth, better all the teeth, may have two radial edges which converge toward the axis of rotation of the machine.

A ratio of the surface area of a slot to the cross section of the wires in the slot may be less than 2.5, or even strictly less than 2.5, notably less than 2.4, or even less than 2.3, better less than 2.2, being for example around just 2.

Reducing this ratio can allow stator developers to better optimize the design of the stator. For example, for a given cross section of wires, and with the same flux density in the stator mass, the mass of the stator mass could be reduced by around 10%. The quality of the exchanges of heat between the wires and the stator mass can be substantially improved in turn, and that can promote better cooling of the windings.

By making the dimensions of the wires and of the slot opening less dependent on one another, it is possible to substantially reduce the slot opening and improve the performance of the magnetic circuit.

Furthermore, increasing the occupation density within a slot is also advantageous as regards a step of impregnating the windings with an impregnating varnish. This is because the invention makes the empty space between the wires smaller, and therefore less varnish is needed to fill this gap. In addition, this makes it possible to encourage the retention of the varnish in the slots until the polymerization step. Increasing the degree to which the slot is filled encourages the retention of the varnish in the slot by the capillary effect, and minimizes the risk of hot spots appearing in the winding.

The invention also relates, independently or in combination with what was stated above, to a rotary electric machine comprising a stator as described above and a rotor.

The machine may be an alternator. It may be an alternator that generates a voltage greater than 100 V, better greater than 200 V, for example greater than 300 V, being for example around 400 V or more.

The voltage supplied may be an AC voltage. It may be a three-phase voltage. The different phases may be distributed in the slots. The winding may be a short-pitch winding.

The power supplied may be around several kVA to multiple MVA.

The stator according to the invention may advantageously be wound for different voltages, frequencies and powers.

The invention also relates, independently or in combination with what was stated above, to a method for manufacturing a stator of a rotary electric machine as described above, in which bundles of round wires are inserted into the slots of the stator by installing them radially into the corresponding slots, starting at one of the axial ends of the machine, with a longitudinal translational movement.

The bundles of wires may be wound in closed turns that have shapes comparable to rectangles with rounded corners, thus forming windings. The various windings of a single phase may be continuous during the formation of the windings. It is possible to have either unitary windings, or a string of windings.

The windings may be formed on winding formers. The winding formers used may be configured to guide and retain the bundles of wires while still keeping the tips of the windings free. This makes it possible to control the arrangement of the wires in the bundles very well. The winding formers may have grooves for receiving the wires. They may have a U-shaped cross section. These grooves that receive the wires may have a width equivalent to, or even slightly less than, the width of a slot.

During the insertion step, the windings are installed in the bore of the stator facing their respective slots, and the wires of the bundles are inserted into the slot through the slot opening. A bundle is installed progressively by threading the wires through the opening one by one. The diameters of the wires making up the bundle are smaller than the width of the slot opening.

However, insofar as the foldable isthmuses are in the open position, the slots are almost completely open onto the bore of the stator. The wires are also distributed within the slots much less chaotically than they are in a conventional semi-open slot.

The windings can firstly be fitted a little way into the bore of the stator mass via one of the axial ends of the machine on the opposite side to their end position, such that the start of the bundles goes into the slot between the isthmuses. A small portion of the bundles is then in the slot, and the rest is on hold in front of the stator mass. The bundles are then longitudinally translationally moved toward the opposite side of the stator mass. In this movement, that portion of the bundles that is outside the stator mass slides into the slots, and the front portions of the bundles that pass through the slot opening finish by emerging at the downstream end of the stator mass. At the end of this translational movement, the bundles are inside the slots.

All in all, a slot can be filled by laying slot end-wall insulation, then inserting a first bundle, then, where appropriate, laying inter-bundle insulation, then inserting a second bundle, and lastly laying slot closing insulation.

This operation is repeated as many times as needed to insert the various windings.

In the method, firstly laminations can be cut out to form the stator mass, the laminations comprising foldable isthmuses extending into the bore of the stator.

While the poles are being cut out, the isthmuses are open, being folded open. They may have edges that converge toward the axis of rotation of the machine.

It is possible for the foldable isthmuses to not be tangential to the bore to form the boundary between the inside of the slot and the central bore of the lamination. Their orientation is radial, instead, and they extend into the bore. They are connected to the teeth by a geometry which subsequently will encourage their change in position. They may also be quite long, since in their future, folded-down position, the foldable isthmuses almost completely close the slots. The foldable isthmuses, which can continue the radial edges of the slots in the bore, do so at a non-zero angle which makes it possible to slightly reduce the slot opening.

The stator mass may be formed from a strip of sheet metal cut into sectors, each sector comprising one or more slots and/or one or more teeth. In a variant, a lamination of the stator mass may be formed by a plurality of sectors joined to one another, each sector comprising one or more slots and/or one or more teeth.

A sector may have cooling channels or cooling fins. During the cutting-out operation, the isthmuses of one sector may be cut out between the cooling fins of another sector. Before the cutting-out operation, they can thus be interlocked.

In the method, at least one foldable isthmus, better all the foldable isthmuses, may form, before being folded down, a non-zero angle with the radial edges of the corresponding slot. The angle may range between 5° and 45°, better between 10° and 40°, or even between 15° and 35°, better still between 20° and 30°. The angle can be small enough to not disrupt the arrangement of the wires as they are being inserted. Moreover, the angle can still be sufficient for the isthmuses to be able to retain the slot closing insulation.

In the method, after the bundles of wires are inserted, the foldable isthmuses can be folded down to make the round wires settle and to partially close the slots of the stator.

The foldable isthmuses are folded down such that they are in the continuation of the teeth of the stator. The contour of the stator at its bore can be cylindrical or substantially cylindrical. Once they are folded down, the foldable isthmuses do not form reliefs in the air gap.

During the insertion step, the wires have access to a larger space than the space in the slot alone. This is because they also have access to a space formed by the open isthmuses before they are folded down. The folding-down of the isthmuses thus forces the wires to settle in the slot, the space formed by the open isthmuses before they are folded down then no longer being available.

When the round wires are being made to settle in the corresponding slot, the round wires can arrange themselves substantially in staggered fashion, given their circular cross section. The internal edges of the isthmuses press against them. The wires do not spread out as much.

### BRIEF DESCRIPTION OF THE DRAWINGS

The invention may be understood better from reading the following detailed description of non-limiting exemplary embodiments thereof and from examining the appended drawing, in which:

FIG. 1 schematically shows a partial cross section through a slot of a stator according to the invention.

FIG. 2 schematically shows a partial cross section through the slot of FIG. 1, with the foldable isthmuses folded back.

FIG. 3a schematically shows a partial cross section through the slot of FIG. 1, superimposed on a slot of the prior art.

FIG. 3b schematically shows a partial cross section through the slot of FIG. 1, with the foldable isthmuses folded back, superimposed on a slot of the prior art.

FIG. 4a schematically shows a partial cross section through the slot of FIG. 1, with the foldable isthmuses folded back.

FIG. 4b is a view similar to FIG. 4a of a slot of the prior art.

FIG. 5 is a view similar to FIG. 2 of a variant embodiment.

FIG. 6 illustrates the method for manufacturing a stator according to the invention.

### DETAILED DESCRIPTION

In the drawing, for the sake of clarity, the respective true proportions of the various constituent elements have not always been respected.

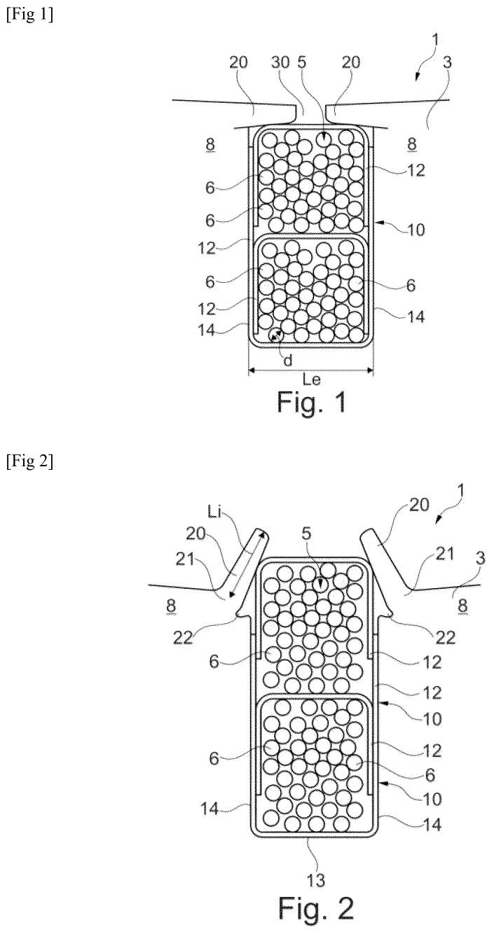

FIG. 1 illustrates a slot 10 of a stator 1 of a rotary electric machine, with a stator mass 3 and a winding 5 disposed in the slot 10.

The winding 5 comprises bundles of round wires 6, the slot 10 comprising, as illustrated, multiple round wires 6 which follow one another circumferentially and radially. A diameter of the round wires 6 may be around 1 mm. It is evident that the diameter of the wires 6 is small compared to the size of a slot 10. A ratio of the wire diameter d to a slot width Le may be around 10, the slot width Le being around 10 mm. It is also evident that the round wires 6 are arranged substantially in staggered fashion in the corresponding slot.

The slot 10 receives a superimposition of two bundles corresponding to two different phases, the bundles of the two phases being isolated, from one another and from the stator mass 3, by thin insulation 12.

The slot 10 is open toward an air gap of the machine and the bore of the stator, and comprises two foldable isthmuses 20 that partially close it. Since the slot is made by cutting it out from laminations, the slots are closed at the air gap by foldable isthmuses 20 which may be integral with the rest of the laminations forming the stator mass 3.

The slot 10 has a flat end wall. The edge 13 of the slot defining the end wall of the slot is rectilinear, with rounded corners. The slot 10 also has two mutually parallel radial edges 14. The slot 10 is thus substantially rectangular.

The stator mass 3 comprises teeth 8 formed between the slots 10. Thus, each slot 10 is semi-closed at the air gap by two foldable isthmuses 20 connected to two consecutive teeth 8 of the stator mass 3. The foldable isthmuses 20 are disposed at the foot of the corresponding tooth 8. The foldable isthmuses 20 are integral with the adjacent teeth 8. Each tooth 8 comprises two foldable isthmuses 20.

Each isthmus 20 has a bridge of material 21 that connects it to the tooth 8 and is deformable, so as to allow a change in the orientation of the isthmus in relation to the corresponding tooth. The foldable isthmus 20 is movable between a first position illustrated in FIG. 2 in which it extends into the bore of the stator, and a second position illustrated in FIG. 1 in which it partially closes the opening of the slot 10, and extends in the continuation of an edge of the tooth 8 defining the bore of the stator.

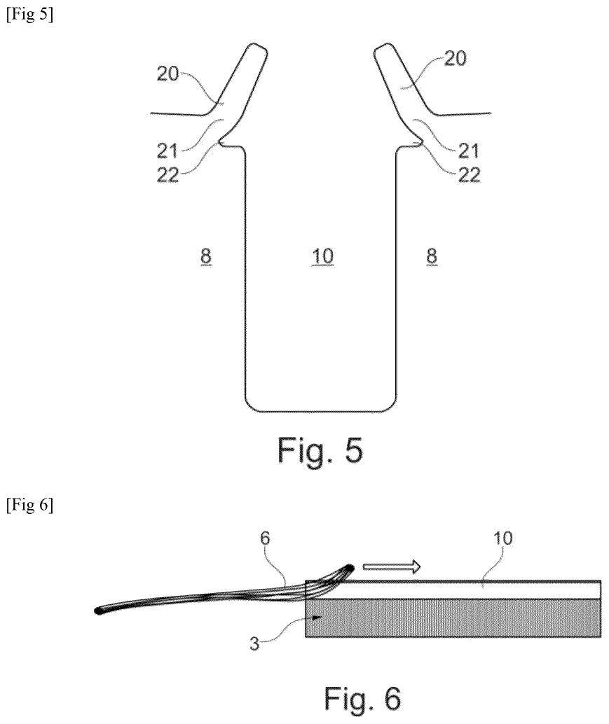

The bridge of material 21 is delimited by a cutout 22 formed at the slot 10, which makes it possible to encourage the folding-down of the corresponding foldable isthmus 20 for partially closing the slot 10. In this example, the cutout 22 has a triangular overall cross section. The cutout 22 forms a notch at the base of the foldable isthmus 20, which makes it possible to encourage the folding-down thereof after the wires are inserted. It may be triangular or any other shape, as illustrated by way of example in FIG. 5, where the cutout 22 is a little deeper.

In the example described, the foldable isthmus 20 has a length Li of approximately 4 mm, i.e. approximately 40% of the slot width. The foldable isthmuses 20 may be quite long, since in their folded-down position, the foldable isthmuses 20 almost completely close the slots 10.

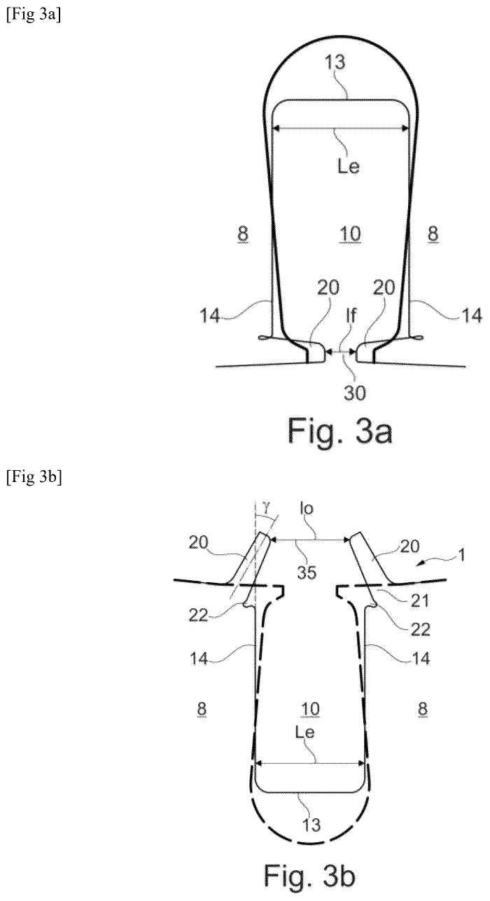

The two foldable isthmuses 20 that partially close the slot 10 form a slot opening 30 between them, a width If of the slot opening 30 formed between the two foldable isthmuses 20 of the slot being, when the isthmuses are folded down, as illustrated in FIGS. 1 and 3a, around 20% of the width Le of the slot.

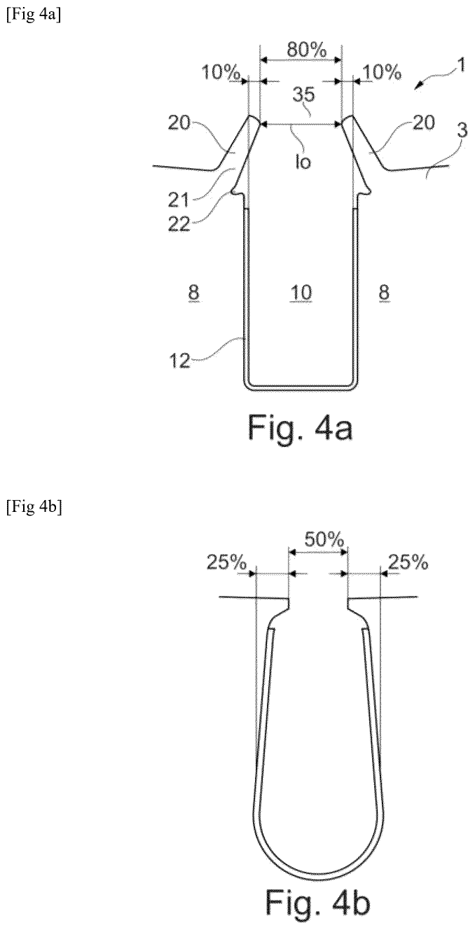

The two foldable isthmuses 20 that partially close a slot 10 form, between them, a slot opening 35, a width lo of the slot opening 35 formed between the two foldable isthmuses of the slot being, when the isthmuses are folded open, as illustrated in FIGS. 4a and 3b, around 80% of the width Le of the slot. For a known semi-closed slot, the ratio may be around 50%, as illustrated in FIG. 4 b.

The method for manufacturing the stator 1 will now be described.

First of all, laminations are cut out to form the stator mass 3, the laminations comprising foldable isthmuses 20 extending into the bore of the stator, as illustrated in FIG. 3b. While the poles are being cut out, the isthmuses 20 are open, being folded open. The foldable isthmuses are not tangential to the bore to form the boundary between the inside of the slot and the central bore of the lamination. Their orientation is radial, instead, and they extend into the bore.

The foldable isthmuses, which continue the radial edges of the slots in the bore, do so at a non-zero angle γ which makes it possible to reduce the slot opening 35. The foldable isthmuses 20 thus, before they are folded down, form a non-zero angle γ with the radial edges 14 of the slot 10. The angle γ is around 22°.

After that, bundles of round wires 6 are inserted into the slots 10 of the stator by installing them radially into the corresponding slots, starting at one of the axial ends of the machine, with a longitudinal translational movement, as illustrated in FIG. 6. Insofar as the foldable isthmuses 20 are in the open position, the slots are almost completely open onto the bore of the stator. The wires are also distributed within the slots much less chaotically than they are in a conventional semi-open slot, as illustrated in FIG. 2.

The windings can firstly be fitted a little way into the bore of the stator mass via one of the axial ends of the machine on the opposite side to their end position, such that the start of the bundles goes into the slot between the isthmuses. A small portion of the bundles is then in the slot, and the rest is on hold in front of the stator mass. The bundles are then longitudinally translationally moved toward the opposite side of the stator mass. In this movement, that portion of the bundles that was outside the stator mass slides into the slots, and the front portions of the bundles that were passed through the slot opening finish by emerging at the downstream end of the stator mass. At the end of this translational movement, the bundles are inside the slots.

All in all, a slot 10 can be filled by laying slot end-wall insulation 12, then inserting a first bundle, then, where appropriate, laying inter-bundle insulation, then inserting a second bundle, and lastly laying slot closing insulation.

After the bundles of wires 6 are inserted, the foldable isthmuses 20 are folded down to make the round wires 6 settle and to partially close the slots 10 of the stator 1, to obtain the configuration in FIG. 1.

The foldable isthmuses 20 are folded down such that they are in the continuation of the teeth 8 of the stator 1. The contour of the stator 1 at its bore is cylindrical or substantially cylindrical. Once they are folded down, the foldable isthmuses 20 do not form reliefs in the air gap.

During the insertion step, the wires 6 have access to a larger space than the space in the slot 10 alone. This is because they also have access to a space formed by the open isthmuses 20 before they are folded down. The folding-down of the isthmuses 20 thus forces the wires 6 to settle in the slot, the space formed by the open isthmuses before they are folded down then no longer being available.

When the round wires 6 are being made to settle in the corresponding slot, the round wires can arrange themselves substantially in staggered fashion, given their circular cross section. The internal edges of the isthmuses press against them. The wires do not spread out as much.

1. A stator of a rotary electric machine, comprising a stator mass having a plurality of slots and a winding disposed in the slots,
the winding comprising bundles of round wires, at least one slot, or even each of the slots, comprising multiple round wires which follow one another circumferentially, and
at least one slot, or even each of the slots, being open toward an air gap of the machine and comprising two foldable isthmuses that partially close the corresponding slot,
at least one foldable isthmus, better all the foldable isthmuses, being configured to form, before being folded down, a non-zero angle with the radial edges of the corresponding slot, the angle ranging between 5° and 45°.

2. The stator as claimed in claim 1, at least one foldable isthmus, better all the foldable isthmuses, having a length (Li) greater than 2 mm.

3. The stator as claimed in claim 1, at least one foldable isthmus, better all the foldable isthmuses, being connected to the corresponding tooth by a bridge of material delimited by a cutout formed at the slot.

4. The stator as claimed in claim 3, the cutout having a triangular overall cross section, notably when the isthmus is folded open.

5. The stator as claimed in claim 1, the two foldable isthmuses that partially close a slot forming a slot opening between them, a width of the slot opening formed between the two foldable isthmuses of the slot being, when the isthmuses are folded down, less than 40% of the width of the slot.

6. The stator as claimed in claim 1, the two foldable isthmuses that partially close a slot forming, between them, a slot opening, a width of the slot opening formed between the two foldable isthmuses of the slot being, when the isthmuses are folded open, greater than 60% of the width of the slot.

7. The stator as claimed in claim 1, at least one slot having a flat end wall.

8. The stator as claimed in claim 1, at least one slot having two mutually parallel radial edges.

9. The stator as claimed in claim 1, at least one tooth having two radial edges which converge toward the axis of rotation of the machine.

10. The stator as claimed in claim 1, a ratio of the surface area of a slot to the cross section of the wires in the slot being less than 2.5.

11. A rotary electric machine comprising a stator as claimed in claim 1 and a rotor.

12. A method for manufacturing a stator of a rotary electric machine as claimed claim 1, in which bundles of round wires are inserted into the slots of the stator by installing them radially into the corresponding slots, starting at one of the axial ends of the machine, with a longitudinal translational movement, in which method at least one foldable isthmus, before being folded down, forms a non-zero angle with the radial edges of the corresponding slot, the angle ranging between 5° and 45°.

13. The method as claimed in claim 12, in which firstly laminations are cut out to form the stator mass, the laminations comprising foldable isthmuses extending into the bore of the stator.

14. The method as claimed in claim 13, in which all the foldable isthmuses, before being folded down, form a non-zero angle (γ) with the radial edges of the corresponding slot.

15. A method for manufacturing a stator of a rotary electric machine as claimed in claim 1, in which bundles of round wires are inserted into the slots of the stator by installing them radially into the corresponding slots, starting at one of the axial ends of the machine, with a longitudinal translational movement,
in which method, after the bundles of wires are inserted, the foldable isthmuses are folded down to make the round wires settle and to partially close the slots of the stator.
